(19) United States
(12) Patent Application Publication
(10) Pub. No.: US 2019/0324767 A1
(43) Pub. Date: Oct. 24, 2019

(54) DECENTRALIZED SHARING OF FEATURES IN FEATURE MANAGEMENT FRAMEWORKS

(71) Applicant: Microsoft Technology Licensing, LLC, Redmond, WA (US)

(72) Inventors: David J. Stein, Mountain View, CA (US); Lei Li, Sunnyvale, CA (US); Ke Wu, Sunnyvale, CA (US); Bee-Chung Chen, San Jose, CA (US); Priyanka Gariba, San Mateo, CA (US)

(73) Assignee: Microsoft Technology Licensing, LLC, Redmond, WA (US)

(21) Appl. No.: 15/959,000

(22) Filed: Apr. 20, 2018

(51) Int. Cl. G06F 9/445; G06F 17/30; G06F 15/18

(52) U.S. Cl. CPC G06F 9/44505; G06F 15/18; G06F 17/30342; G06F 17/3056

(57) ABSTRACT

The disclosed embodiments provide a system for sharing features in a feature management framework. During operation, the system creates a repository of feature configurations for a set of features that are accessed across multiple environments. Next, the system identifies dependencies of the repository. The system then copies shared feature configurations from other repositories represented by the dependencies. Finally, the system combines the shared feature configurations with existing feature configurations in the repository for use in retrieving feature values for one or more machine learning models.

### RELATED APPLICATIONS

The subject matter of this application is related to the subject matter in a co-pending non-provisional application entitled “Common Feature Protocol for Collaborative Machine Learning,” having Ser. No. 15/046,199, and filing date 17 Feb. 2016 (Attorney Docket No. LI-901891-US-NP).

The subject matter of this application is also related to the subject matter in a co-pending non-provisional application entitled “Framework for Managing Features Across Environments,” having serial number TO BE ASSIGNED, and filing date TO BE ASSIGNED (Attorney Docket No. LI-902216-US-NP).

The subject matter of this application is also related to the subject matter in a co-pending non-provisional application entitled “Managing Derived and Multi-Entity Features Across Environments,” having serial number TO BE ASSIGNED, and filing date TO BE ASSIGNED (Attorney Docket No. LI-902217-US-NP).

### BACKGROUND

### Field

The disclosed embodiments relate to machine learning systems. More specifically, the disclosed embodiments relate to techniques for performing decentralized sharing of features in feature management frameworks.

### Related Art

Analytics may be used to discover trends, patterns, relationships, and/or other attributes related to large sets of complex, interconnected, and/or multidimensional data. In turn, the discovered information may be used to gain insights and/or guide decisions and/or actions related to the data. For example, business analytics may be used to assess past performance, guide business planning, and/or identify actions that may improve future performance.

To glean such insights, large data sets of features may be analyzed using regression models, artificial neural networks, support vector machines, decision trees, naïve Bayes classifiers, and/or other types of machine-learning models. The discovered information may then be used to guide decisions and/or perform actions related to the data. For example, the output of a machine-learning model may be used to guide marketing decisions, assess risk, detect fraud, predict behavior, and/or customize or optimize use of an application or website.

However, significant time, effort, and overhead may be spent on feature selection during creation and training of machine-learning models for analytics. For example, a data set for a machine-learning model may have thousands to millions of features, including features that are created from combinations of other features, while only a fraction of the features and/or combinations may be relevant and/or important to the machine-learning model. At the same time, training and/or execution of machine-learning models with large numbers of features typically require more memory, computational resources, and time than those of machine-learning models with smaller numbers of features. Excessively complex machine-learning models that utilize too many features may additionally be at risk for overfitting.

Additional overhead and complexity may be incurred during sharing and organizing of feature sets. For example, a set of features may be shared across projects, teams, or usage contexts by denormalizing and duplicating the features in separate feature repositories for offline and online execution environments. As a result, the duplicated features may occupy significant storage resources and require synchronization across the repositories. Each team that uses the features may further incur the overhead of manually identifying features that are relevant to the team's operation from a much larger list of features for all of the teams. The same features may further be identified and/or specified multiple times during different steps associated with creating, training, validating, and/or executing the same machine-learning model.

Consequently, creation and use of machine-learning models in analytics may be facilitated by mechanisms for improving the monitoring, management, sharing, propagation, and reuse of features among the machine-learning models.

### BRIEF DESCRIPTION OF THE FIGURES

FIG. 1 shows a schematic of a system in accordance with the disclosed embodiments.

FIG. 2 shows a system for processing data in accordance with the disclosed embodiments.

FIG. 3 shows a flowchart illustrating a process of sharing features in a feature management framework in accordance with the disclosed embodiments.

FIG. 4 shows a flowchart illustrating a process of combining feature configurations in a repository in accordance with the disclosed embodiments.

FIG. 5 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

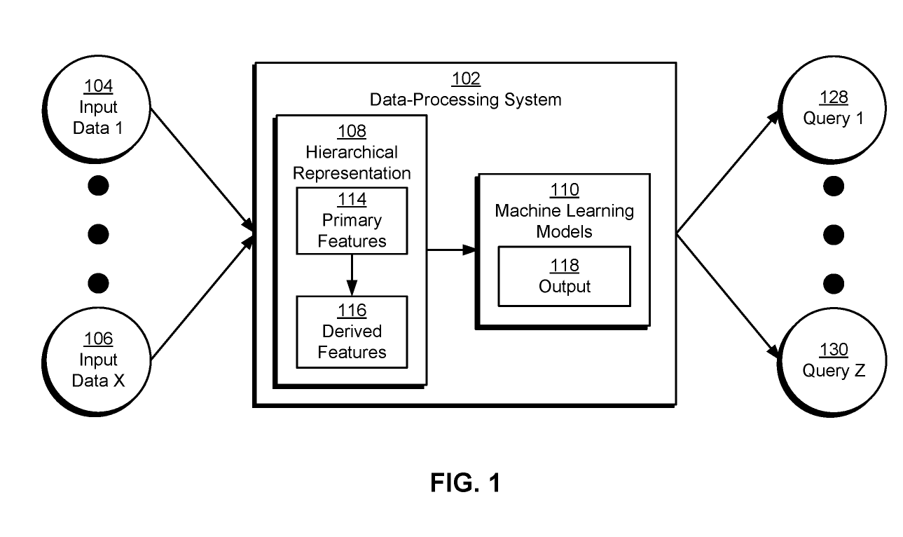

The disclosed embodiments provide a method, apparatus, and system for processing data. As shown in FIG. 1, the system includes a data-processing system 102 that analyzes one or more sets of input data (e.g., input data 1 104, input data x 106). For example, data-processing system 102 may create and train one or more machine learning models 110 for analyzing input data related to users, organizations, applications, job postings, purchases, electronic devices, websites, content, sensor measurements, and/or other categories. Machine learning models 110 may include, but are not limited to, regression models, artificial neural networks, support vector machines, decision trees, naïve Bayes classifiers, Bayesian networks, deep learning models, hierarchical models, and/or ensemble models.

In turn, the results of such analysis may be used to discover relationships, patterns, and/or trends in the data; gain insights from the input data; and/or guide decisions or actions related to the data. For example, data-processing system 102 may use machine learning models 110 to generate output 118 that includes scores, classifications, recommendations, estimates, predictions, and/or other properties. Output 118 may be inferred or extracted from primary features 114 in the input data and/or derived features 116 that are generated from primary features 114 and/or other derived features. For example, primary features 114 may include profile data, user activity, sensor data, and/or other data that is extracted directly from fields or records in the input data. The primary features 114 may be aggregated, scaled, combined, and/or otherwise transformed to produce derived features 116, which in turn may be further combined or transformed with one another and/or the primary features to generate additional derived features. After output 118 is generated from one or more sets of primary and/or derived features, output 118 is provided in responses to queries (e.g., query 1 128, query z 130) of data-processing system 102. In turn, the queried output 118 may improve revenue, interaction with the users and/or organizations, use of the applications and/or content, and/or other metrics associated with the input data.

In one or more embodiments, data-processing system 102 uses a hierarchical representation 108 of primary features 114 and derived features 116 to organize the sharing, production, and consumption of the features across different teams, execution environments, and/or projects. Hierarchical representation 108 may include a directed acyclic graph (DAG) that defines a set of namespaces for primary features 114 and derived features 116. The namespaces may disambiguate among features with similar names or definitions from different usage contexts or execution environments. Hierarchical representation 108 may include additional information that can be used to locate primary features 114 in different execution environments, calculate derived features 116 from the primary features and/or other derived features, and track the development of machine learning models 110 or applications that accept the derived features as input.

Consequently, data-processing system 102 may implement, in hierarchical representation 108, a common feature protocol that describes a feature set in a centralized and structured manner, which in turn can be used to coordinate large-scale and/or collaborative machine learning across multiple entities and machine learning models 110. Common feature protocols for large-scale collaborative machine learning are described in a co-pending non-provisional application entitled “Common Feature Protocol for Collaborative Machine Learning,” having Ser. No. 15/046,199, and filing date 17 Feb. 2016 (Attorney Docket No. LI-901891-US-NP), which is incorporated herein by reference.

In one or more embodiments, primary features 114 and/or derived features 116 are obtained and/or used with an online professional network, social network, or other community of users that is used by a set of entities to interact with one another in a professional, social, and/or business context. The entities may include users that use the online professional network to establish and maintain professional connections, list work and community experience, endorse and/or recommend one another, search and apply for jobs, and/or perform other actions. The entities may also include companies, employers, and/or recruiters that use the online professional network to list jobs, search for potential candidates, provide business-related updates to users, advertise, and/or take other action.

As a result, features 114 and/or derived features 116 may include member features, company features, and/or job features. The member features include attributes from the members' profiles with the online professional network, such as each member's title, skills, work experience, education, seniority, industry, location, and/or profile completeness. The member features also include each member's number of connections in the online professional network, the member's tenure on the online professional network, and/or other metrics related to the member's overall interaction or “footprint” in the online professional network. The member features further include attributes that are specific to one or more features of the online professional network, such as a classification of the member as a job seeker or non-job-seeker.

The member features may also characterize the activity of the members with the online professional network. For example, the member features may include an activity level of each member, which may be binary (e.g., dormant or active) or calculated by aggregating different types of activities into an overall activity count and/or a bucketized activity score. The member features may also include attributes (e.g., activity frequency, dormancy, total number of user actions, average number of user actions, etc.) related to specific types of social or online professional network activity, such as messaging activity (e.g., sending messages within the online professional network), publishing activity (e.g., publishing posts or articles in the online professional network), mobile activity (e.g., accessing the social network through a mobile device), job search activity (e.g., job searches, page views for job listings, job applications, etc.), and/or email activity (e.g., accessing the online professional network through email or email notifications).

The company features include attributes and/or metrics associated with companies. For example, company features for a company may include demographic attributes such as a location, an industry, an age, and/or a size (e.g., small business, medium/enterprise, global/large, number of employees, etc.) of the company. The company features may further include a measure of dispersion in the company, such as a number of unique regions (e.g., metropolitan areas, counties, cities, states, countries, etc.) to which the employees and/or members of the online professional network from the company belong.

A portion of company features may relate to behavior or spending with a number of products, such as recruiting, sales, marketing, advertising, and/or educational technology solutions offered by or through the online professional network. For example, the company features may also include recruitment-based features, such as the number of recruiters, a potential spending of the company with a recruiting solution, a number of hires over a recent period (e.g., the last 12 months), and/or the same number of hires divided by the total number of employees and/or members of the online professional network in the company. In turn, the recruitment-based features may be used to characterize and/or predict the company's behavior or preferences with respect to one or more variants of a recruiting solution offered through and/or within the online professional network.

The company features may also represent a company's level of engagement with and/or presence on the online professional network. For example, the company features may include a number of employees who are members of the online professional network, a number of employees at a certain level of seniority (e.g., entry level, mid-level, manager level, senior level, etc.) who are members of the online professional network, and/or a number of employees with certain roles (e.g., engineer, manager, sales, marketing, recruiting, executive, etc.) who are members of the online professional network. The company features may also include the number of online professional network members at the company with connections to employees of the online professional network, the number of connections among employees in the company, and/or the number of followers of the company in the online professional network. The company features may further track visits to the online professional network from employees of the company, such as the number of employees at the company who have visited the online professional network over a recent period (e.g., the last 30 days) and/or the same number of visitors divided by the total number of online professional network members at the company.

One or more company features may additionally be derived features 116 that are generated from member features. For example, the company features may include measures of aggregated member activity for specific activity types (e.g., profile views, page views, jobs, searches, purchases, endorsements, messaging, content views, invitations, connections, recommendations, advertisements, etc.), member segments (e.g., groups of members that share one or more common attributes, such as members in the same location and/or industry), and companies. In turn, the company features may be used to glean company-level insights or trends from member-level online professional network data, perform statistical inference at the company and/or member segment level, and/or guide decisions related to business-to-business (B2B) marketing or sales activities.

The job features describe and/or relate to job listings and/or job recommendations within the online professional network. For example, the job features may include declared or inferred attributes of a job, such as the job's title, industry, seniority, desired skill and experience, salary range, and/or location. One or more job features may also be derived features 116 that are generated from member features and/or company features. For example, the job features may provide a context of each member's impression of a job listing or job description. The context may include a time and location (e.g., geographic location, application, website, web page, etc.) at which the job listing or description is viewed by the member. In another example, some job features may be calculated as cross products, cosine similarities, statistics, and/or other combinations, aggregations, scaling, and/or transformations of member features, company features, and/or other job features.

Those skilled in the art will appreciate that primary features 114 and/or derived features 116 may be obtained from multiple data sources, which in turn may be distributed across different environments. For example, the features may be obtained from data sources in online, offline, nearline, streaming, and/or search-based execution environments. In addition, each data source and/or environment may have a separate application-programming interface (API) for retrieving and/or transforming the corresponding features. Consequently, managing, sharing, obtaining, and/or calculating features across the environments may require significant overhead and/or customization to specific environments and/or data sources.

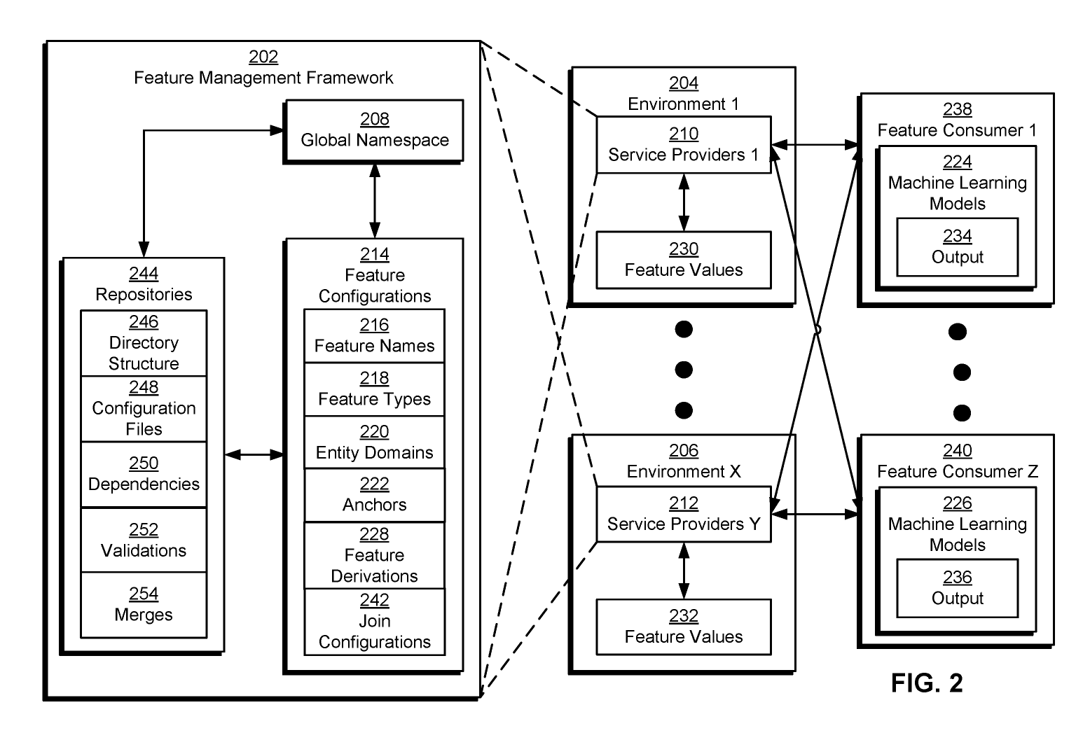

In one or more embodiments, data-processing system 102 includes functionality to perform centralized feature management in a way that is decoupled from environments, systems, and/or use cases of the features. As shown in FIG. 2, a system for processing data (e.g., data-processing system 102 of FIG. 1) includes a feature management framework 202 that executes in and/or is deployed across a number of service providers (e.g., service providers 1 210, service providers y 212) in different environments (e.g., environment 1 204, environment x 206).

The environments include different execution contexts and/or groups of hardware and/or software resources in which feature values 230-232 of the features can be obtained or calculated. For example, the environments may include an online environment that provides real-time feature values, a nearline or streaming environment that emits events containing near-realtime records of updated feature values, an offline environment that calculates feature values on a periodic and/or batch-processing basis, and/or a search-based environment that performs fast reads of databases and/or other data stores in response to queries for data in the data stores.

One or more environments may additionally be contained or nested in one or more other environments. For example, an online environment may include a “remix” environment that contains a library framework for executing one or more applications and/or generating additional features.

The service providers may include applications, processes, jobs, services, and/or modules for generating and/or retrieving feature values 230-232 for use by a number of feature consumers (e.g., feature consumer 1 238, feature consumer z 240). The feature consumers may use one or more sets of feature values 230-232 as input to one or more machine learning models 224-226 during training, testing, and/or validation of machine learning models 224-226 and/or scoring using machine learning models 224-226. In turn, output 234-236 generated by machine learning models 224-226 from the sets of feature values 230-232 may be used by the feature consumers and/or other components to adjust parameters and/or hyperparameters of machine-learning models 224-226; verify the performance of machine-learning models 224-226; select versions of machine-learning models 224-226 for use in production or real-world settings; and/or make inferences, recommendations, predictions, and/or estimates related to feature values 230-232 within the production or real-world settings.

In one or more embodiments, the service providers use components of feature management framework 202 to generate and/or retrieve feature values 230-232 of features from the environments in a way that is decoupled from the locations of the features and/or operations or computations used to generate or retrieve the corresponding feature values 230-232 within the environments. First, the service providers organize the features within a global namespace 208 that spans the environments. Global namespace 208 may include a hierarchical representation of feature names 216 and use scoping relationships in the hierarchical representation to disambiguate among features with common or similar names, as described in the above-referenced application. Consequently, global namespace 208 may replace references to locations of the features (e.g., filesystem paths, network locations, streams, tables, fields, services, etc.) with higher-level abstractions for identifying and accessing the features.

Second, the service providers use feature configurations 214 in feature management framework 202 to define, identify, locate, retrieve, and/or calculate features from the respective environments. Each feature configuration includes metadata and/or information related to one or more features in global namespace 208. Individual feature configurations 214 can be independently created and/or updated by a user, team, and/or entity without requiring knowledge of feature configurations 214 for other features and/or from other users, teams, and/or entities.

Feature configurations 214 include feature names 216, feature types 218, entity domains 220, anchors 222, feature derivations 228, and join configurations 242 associated with the features. Feature names 216 include globally scoped identifiers for the features, as obtained from and/or maintained using global namespace 208. For example, a feature representing the title in a member's profile with a social network or online professional network may have a globally namespaced feature name of “org.member.profile.title.” The feature name may allow the feature to be distinguished from a different feature for a title in a job listing, which may have a globally namespaced feature name of “org.job.title.”

Feature types 218 include semantic types that describe how the features can be used with machine learning models 224-226. For example, each feature may be assigned a feature type that is numeric, binary, categorical, categorical set, categorical bag, and/or vector. The numeric type represents numeric values such as real numbers, integers, and/or natural numbers. The numeric type may be used with features such as numeric identifiers, metrics (e.g., page views, messages, login attempts, user sessions, click-through rates, conversion rates, spending amounts, etc.), statistics (e.g., mean, median, maximum, minimum, mode, percentile, etc.), scores (e.g., connection scores, reputation scores, propensity scores, etc.), and/or other types of numeric data or measurements.

The binary feature type includes Boolean values of 1 and 0 that indicate if a corresponding attribute is true or false. For example, binary features may specify a state of a member (e.g., active or inactive) and/or whether a condition has or has not been met.

Categorical, categorical set, and categorical bag feature types include fixed and/or limited names, labels, and/or other qualitative attributes. For example, a categorical feature may represent a single instance of a color (e.g., red, blue, yellow, green, etc.), a type of fruit (e.g., orange, apple, banana, etc.), a blood type (e.g., A, B, AB, O, etc.), and/or a breed of dog (e.g., collie, shepherd, terrier, etc.). A categorical set may include one or more unique values of a given categorical feature, such as {apple, banana, orange} for the types of fruit found in a given collection. A categorical bag may include counts of the values, such as {banana: 2, orange: 3} for a collection of five pieces of fruit and/or a bag of words from a sentence or text document.

The vector feature type represents an array of features, with each dimension or element of the array corresponding to a different feature. For example, a feature vector may include an array of metrics and/or scores for characterizing a member of a social network. In turn, a metric such as Euclidean distance or cosine similarity may be calculated from feature vectors of two members to measure the similarity, affinity, and/or compatibility of the members.

Entity domains 220 identify classes of entities described by the features. For example, entity domains 220 for features related to a social network or online professional network may include members, jobs, groups, companies, products, business units, advertising campaigns, and/or experiments. Entity domains 220 may be encoded and/or identified within global namespace 208 (e.g., “jobs.title” versus “member.title” for features related to professional titles) and/or specified separately from global namespace 208 (e.g., “featurel.entitydomain=members”). One or more features may additionally have compound entity domains 220. For example, an interaction feature between members and jobs may have an entity domain of {members, jobs}.

Anchors 222 include metadata that describes how to access the features in specific environments. For example, anchors 222 may include locations or paths of the features in the environments; classes, functions, methods, calls, and/or other mechanisms for accessing data related to the features; and/or formulas or operations for calculating and/or generating the features from the data.

A service provider may use an anchor for accessing a feature in the service provider's environment to retrieve and/or calculate one or more feature values (e.g., feature values 230-232) for the feature and provide the feature values to a feature consumer. For example, the service provider may receive, from a feature consumer, a request for obtaining feature values of one or more features from the service provider's environment. The service provider may match feature names in the request to one or more anchors 222 for the corresponding features and use the anchors and one or more entity keys (e.g., member keys, job keys, company keys, etc.) in the request to obtain feature values for the corresponding entities from the environment. The service provider may optionally format the feature values according to parameters in the request and return the feature values to the feature consumer for use in training, testing, validating, and/or executing machine learning models (e.g., machine learning models 224-226) associated with the feature consumer.

Join configurations 242 include metadata that is used to join feature values for one or more features with observation data associated with the feature values. Each join configuration may identify the features and observation data and include one or more join keys that are used by the service provider to perform join operations. In turn, a service provider may use a join configuration to generate data that is used in training, testing, and/or validation of a machine learning model. Using anchors and join configurations to access features in various environments is described in a co-pending non-provisional application filed on the same day as the instant application, entitled “Framework for Managing Features Across Environments,” having serial number TO BE ASSIGNED, and filing date TO BE ASSIGNED (Attorney Docket No. LI-902216-US-NP), which is incorporated herein by reference.

Feature derivations 228 include metadata for calculating or generating derived features (e.g., derived features 116 of FIG. 1) from other “input” features, such as primary features with anchors 222 in the respective environments and/or other derived features. For example, feature derivations 228 may include expressions, operations, and/or references to code for generating or calculating the derived features from other features. Like anchors 222, feature derivations 228 may identify features by globally namespaced feature names 216 and/or be associated with specific environments. For example, a feature derivation may specify one or more input features used to calculate a derived feature and/or one or more environments in which the input features can be accessed.

In turn, a service provider uses feature derivations 228 to verify the reachability of a derived feature in the service provider's environment, generate a dependency graph of features used to produce the derived feature, verify a compatibility of the derived feature with input features used to generate the derived feature, and obtain and/or calculate features in the dependency graph according to the determined evaluation order. Using feature derivations to generate derived features across environments is described in a co-pending non-provisional application filed on the same day as the instant application, entitled “Managing Derived and Multi-Entity Features Across Environments,” having serial number TO BE ASSIGNED, and filing date TO BE ASSIGNED (Attorney Docket No. LI-902217-US-NP), which is incorporated herein by reference.

In one or more embodiments, feature management framework 202 includes functionality to perform decentralized, modular sharing of feature configurations 214 and/or other metadata used to access, generate, and/or format features in multiple environments. As shown in FIG. 2, feature management framework 202 includes a set of repositories 244 for storing, synchronizing, and/or sharing the metadata.

A team, project, and/or other entity associated with producing, consuming, and/or managing features using feature management framework 202 may create a local repository for storing and organizing feature configurations 214. The local repository may adhere to a directory structure 246 that allows the metadata to be located, shared, and/or merged with metadata from repositories for other entities.

To allow other teams, projects, and/or entities to use features that are created or managed by the entity, the entity may include feature configurations 214 and/or other metadata for the features in one or more configuration files 248 that are placed in specific locations within directory structure 246. For example, the entity may store configuration files 248 containing feature configurations 214 for shared features in directories that are designated as shared and/or set permissions for those configuration files 248 to “shared.” On the other hand, the entity may store configuration files 248 containing feature configurations 214 for private features (e.g., features that are used only by the entity) in directories that are designated as private and/or set permissions for those configuration files 248 to “private.” In another example, the entity may specify, for a given configuration file and/or directory in directory structure 246, a specific set of entities that have been granted access to feature configurations 214 in the configuration file and/or directory.

To use features that are created and/or managed by other entities, the entity may specify dependencies 250 on repositories of the other entities. In turn, a synchronization mechanism associated with the entity's repository may copy configuration files 248 containing feature configurations 214 for the other entities' features to the entity's repository. The synchronization mechanism may also apply a set of validations 252 to the copied configuration files 248 before the synchronization mechanism merges 254 the copied configuration files with existing configuration files 248 in the repository. After configuration files 248 from other repositories are validated and merged into the local repository, configuration files 248 may be deployed to one or more service providers used by the entity. In turn, the entity may use the service providers and deployed feature configurations to obtain feature values for the corresponding features and use the features values to train, test, validate, and/or execute machine learning models.

For example, feature management framework 202 may provide a template for organizing feature configurations 214 within a repository. As a result, the entity may use the template to create a repository on a computer system owned or managed by the entity. The template may include directory structure 246, as well as one or more files for storing and/or sharing feature configurations 214 and/or other metadata used to retrieve, calculate, and/or join features and/or specify and resolve dependencies 250 of the repository.

A template for creating one or more repositories 244 may include the following example directory structure 246:

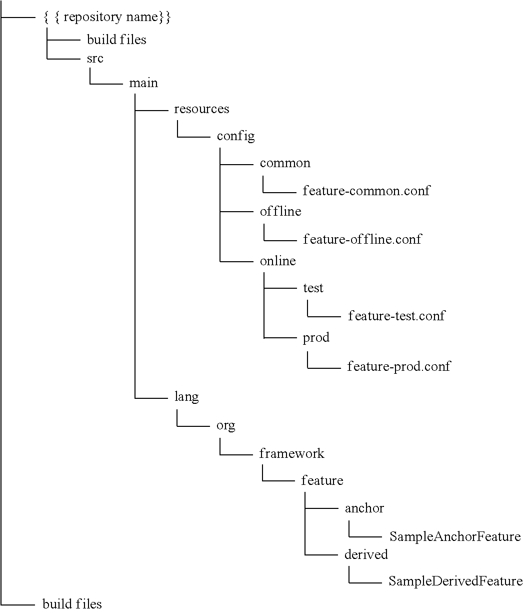

The highest level of the example directory structure 246 above includes a directory that identifies the repository (i.e., “{{repository name} }”). Below the top-level directory, directory structure 246 is organized into a hierarchy of sub-directories storing different files related to accessing, sharing, and using features within feature management framework 202.

Multiple directories under “src/main/resources/config” are used to store configuration files 248 containing feature configurations 214. An “offline” directory includes feature configurations 214 for features that are accessed in an offline environment, and an “online” directory includes feature configurations 214 for features that are accessed in one or more online environments. The “online” directory further includes two subdirectories; a “test” subdirectory stores feature configurations 214 for accessing features in an online testing environment, and a “prod” subdirectory stores feature configurations 214 for accessing features in an online production environment. A “common” directory stores components of feature configurations 214 (e.g., anchors 222, feature derivations 228, join configurations 242, etc.) that can be used to access features in both the offline and online environments.

Each directory under “src/main/resources/config” further includes a configuration file containing the corresponding feature configurations 214. For example, the “common” directory includes a configuration file named “feature-common.conf,” the “offline” directory includes a configuration file named “feature-offline.conf,” the “online/test” directory includes a configuration file named “feature-test.conf,” and the “online/prod” directory includes a configuration file named “feature-prod.conf.”

Configuration files 248 in directory structure 246 may adhere to a set of requirements and/or standards to facilitate subsequent sharing and/or merging of feature configurations 214 across repositories. First, each configuration file may have a predefined name and/or follow a naming convention to facilitate identification of configuration files 248 within the repository and/or determine if any configuration files 248 are to be shared with other repositories. For example, every configuration file that stores feature configurations 214 in repositories 244 may have a prefix of “feature-” and a file extension of “conf.”

Second, feature configurations 214 for a given environment or set of environments may be stored in a single configuration file within the corresponding directory for the environment(s). For example, configuration files 248 in the “common,” “offline,” “online/test,” and “online/prod” directories may be assigned predefined names of “feature-common.conf,” “feature-offline.conf,” “feature-test.conf,” and “feature-prod.conf” that are provided with the template. To enable sharing of feature configurations for a given environment or set of environments, a feature producer may store the feature configurations in the corresponding named configuration file within directory structure 246. Conversely, the feature producer may store feature configurations for features that are not shared with other entities in configuration files 248 with non-predefined names and/or in other directories (e.g., a “private” directory) within directory structure 246.

Third, each configuration file may optionally define a namespace for feature names 216 and/or feature configurations 214 in the configuration file. For example, the namespace may be included at the top of the configuration file and added to global namespace 208 after the contents of the configuration file have been verified to meet all requirements. The namespace may be concatenated with feature names 216 in the configuration file to disambiguate between features with the same feature names and/or uniquely identify features within feature management framework 202. Feature versions (e.g., version numbers) may further be appended to the concatenated feature names 216 to provide additional tracking and/or resolution of features in feature management framework 202. Thus, a feature named “title” in a namespace of “org.member.profileFeature” with a version of 0.1.0 may have a formal name of “org.member.profileFeature.title:0.1.0,” which can be used to resolve the feature within global namespace 208.

The example directory structure 246 above also includes multiple directories under “lang/org/framework/feature” for storing user-defined functions (UDFs) that can be used with anchors 222, feature derivations 228, and/or join configurations 242 to produce feature values for the corresponding features. For example, the “anchor” directory may store a file named “SampleAnchorFeature,” and the “derived” directory may store a file named “SampleDerivedFeature.” The “SampleAnchorFeature” file may be renamed and/or modified to store UDFs for retrieving feature values using anchors 222, and the “SampleDerivedFeature” file may be renamed and/or modified to store UDFs for generating feature values using feature derivations 228.

Build files are also included in one or more levels of the example directory structure 246 above. The build files may specify parameters that are used to coordinate the sharing of configuration files 248 with other repositories and/or obtain configuration files 248 from the other repositories. For example, the build files may specify permissions associated with each configuration file, such as one or more repositories and/or entities that are allowed to access and/or copy the configuration file. The permissions may thus allow a feature producer to apply finer-grained access control to feature configurations 214 and/or configuration files 248, in lieu of or in addition to designating one or more configuration files 248 as shared or private in feature producer's repository.

The build files may additionally contain dependencies 250 of the repository. For example, one or more build files in directory structure 246 may identify dependencies 250 using repository names, repository locations, filenames, team names, project names, and/or other information that can be used to identify other repositories and/or configuration files representing dependencies 250.

A module, plug-in, and/or other mechanism for sharing or synchronizing configuration files 248 across repositories 244 may obtain dependencies 250 from build files and/or other data within directory structure 246 and copy configuration files 248 represented by dependencies 250 from other repositories into the local repository. For example, the mechanism may copy the configuration files from the other repositories into one or more temporary directories in the local repository.

The mechanism may also perform validations 252 of feature names 216, feature versions, and/or other attributes of the copied configuration files 248. For example, the mechanism may verify that each feature name in the copied configuration files 248 has a valid feature configuration and is not used more than once in the same namespace. The mechanism may also, or instead, verify that feature versions in the copied configuration files 248 are valid and have not been deprecated or “retired.” The mechanism may further verify that join configurations 242 in the copied configuration files 248 include feature names and/or versions that are valid, not deprecated, and/or available in the corresponding data sources.

Finally, after configuration files 248 have been validated, the mechanism may perform merges 254 of the copied configuration files with existing configuration files in the repository. For example, the mechanism may “compile” feature configurations 214 in two or more configuration files for the same environment or set of environments (e.g., offline, online testing, online production, common, etc.) into a single configuration file that is stored in the directory for that environment or set of environments. If the configuration files are merged successfully, the mechanism may delete the copied configuration files and/or temporary directories in which the copied configuration files reside. The mechanism may also deploy feature configurations 214 in the configuration files in one or more service providers within the corresponding environment(s), and the service provider(s) may use the deployed feature configurations 214 to retrieve feature values for use with one or more machine learning models. If an error is encountered during the merging process, the mechanism may output a notification, alert, or message containing the error for subsequent resolution by a user.

By using repositories 244 to store, update, and share configuration files 248 containing feature configurations 214, feature management framework 202 may allow features to be added, removed, modified, and/or shared among feature producers and feature consumers in a decentralized, modular way. In particular, each repository may allow a feature producer, feature consumer, and/or other entity to define and organize features across multiple environments in a manner that is consistent within the entity but independent of feature definition and organization performed by other entities. At the same time, dependencies 250 may allow the entity to obtain feature configurations 214 in an on-demand basis from other entities and use anchors 222, feature derivations 228, and join configurations 242 in the feature configurations to access and use the corresponding features. Consequently, the system may provide technological improvements related to the development and use of computer systems, applications, services, and/or workflows for producing features, consuming features, sharing features across teams and/or projects, and/or using features with machine learning models.

Those skilled in the art will appreciate that the system of FIG. 2 may be implemented in a variety of ways. First, feature management framework 202, repositories 244, the service providers, and/or the environments may be provided by a single physical machine, multiple computer systems, one or more virtual machines, a grid, one or more databases, one or more filesystems, and/or a cloud computing system. Moreover, various components of the system may be configured to execute in an offline, online, and/or nearline basis to perform different types of processing related to managing, accessing, sharing, and using features, feature values, feature configurations 214, and machine learning models 224-226.

Second, feature configurations 214, feature values, and/or other data used by the system may be stored, defined, and/or transmitted using a number of techniques. For example, the system may be configured to accept features from different types of repositories, including relational databases, graph databases, data warehouses, filesystems, streams, online data stores, and/or flat files. The system may also obtain and/or transmit feature configurations 214, feature values, and/or other data used by or with feature management framework 202 in a number of formats, including database records, property lists, Extensible Markup language (XML) documents, JavaScript Object Notation (JSON) objects, and/or other types of structured data. Each feature configuration may further encompass one or more features, anchors 222, feature derivations 228, join configurations 242, service providers, and/or environments.

Similarly, repositories 244 may be created, distributed, and/or synchronized in a number of ways. For example, a single repository may be created for each team, project, or entity associated with a set of features, or multiple repositories 244 may be maintained by the entity to manage the definition, sharing, and organization of multiple feature sets. In another example, directory structure 246 may be modified to support configuration files 248 and/or feature configurations 214 from multiple entities in a single repository when sharing of feature sets associated with the feature configurations by the entities is desired. In a third example, repositories 244 for individual entities involved in creating and/or consuming features may be synchronized with a centralized database and/or repository that updates global namespace 208 with feature names, feature versions, feature configuration versions, and/or other metadata used to manage the sharing of features across environments, entities, and/or service providers. In a fourth example, a repository may be configured to copy and merge configuration files 248 from other repositories designated as dependencies 250 of the repository on a periodic, manual (e.g., based on user input), and/or on-demand (e.g., prior to retrieval or use of features defined using the other repositories) basis.

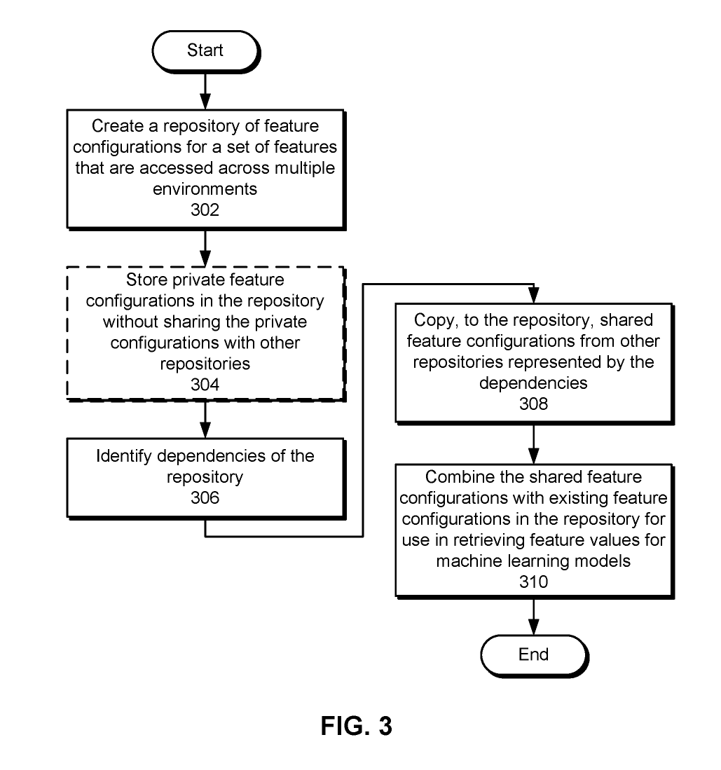

FIG. 3 shows a flowchart illustrating a process of sharing features in a feature management framework in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the embodiments.

Initially, a repository of feature configurations for a set of features that are accessed across multiple environments is created (operation 302). For example, the repository may be created from a template for organizing the feature configurations. The template may include a directory structure for the repository, one or more configuration files, and/or one or more build files.

After the repository is created, private feature configurations may optionally be stored in the repository without sharing the private configurations with other repositories (operation 304). For example, the private feature configurations may be included in one or more configuration files that are designated as private and/or placed in private directories within the repository. Conversely, feature configurations for features that are shared within the feature management framework may be placed in configuration files that are designated as public and/or placed in public or “shared” directories within the repository.

To use features that are defined in other repositories, dependencies of the repository are identified (operation 306), and shared feature configurations from other repositories represented by the dependencies are copied to the repository (operation 308). For example, the other repositories may be used by feature producers to define, manage, and/or track the production of the features independently of consumption of the features by a feature consumer associated with the repository. The dependencies may be obtained from one or more build files, and one or more attributes of the dependencies (e.g., names, identifiers, network locations, etc.) may be used to resolve the other repositories. Configuration files containing feature configurations for shared features may then be retrieved from the other repositories and copied to a temporary directory in the repository.

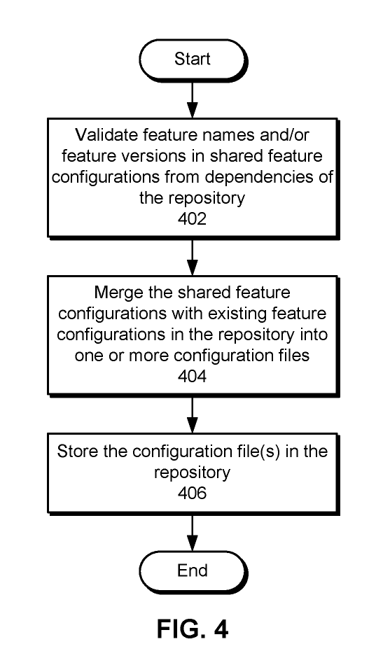

Finally, the shared feature configurations are combined with existing feature configurations in the repository for use in retrieving feature values for machine learning models (operation 310), as described in further detail below with respect to FIG. 4. For example, the shared feature configurations may include anchors, feature derivations, join configurations, and/or other metadata that allow a feature consumer associated with the repository to obtain and use features from the feature producers after the shared feature configurations are successfully combined with the existing feature configurations in the repository.

FIG. 4 shows a flowchart illustrating a process of combining feature configurations in a repository in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

First, feature names and/or feature versions in shared feature configurations from dependencies of the repository are validated (operation 402). As discussed above, the dependencies may include other repositories that are managed and/or used by other entities, such as teams, projects, and/or individuals involved in producing features. The feature names may be validated by checking the feature names for misspellings, duplicates, and/or valid feature configurations. The feature versions may be validated by verifying that all feature version numbers are correctly formatted and have not been deprecated or “retired.”

Next, the shared feature configurations are merged with existing feature configurations in the repository into one or more configuration files (operation 404). For example, feature configurations from the dependencies may be “compiled” with the existing feature configurations into a single configuration file for each environment and/or set of environments to which the feature configurations pertain.

The configuration file(s) are then stored in the repository (operation 406). For example, each configuration file may be stored in a directory representing one or more environments in which feature configurations in the configuration file can be used to retrieve feature values.

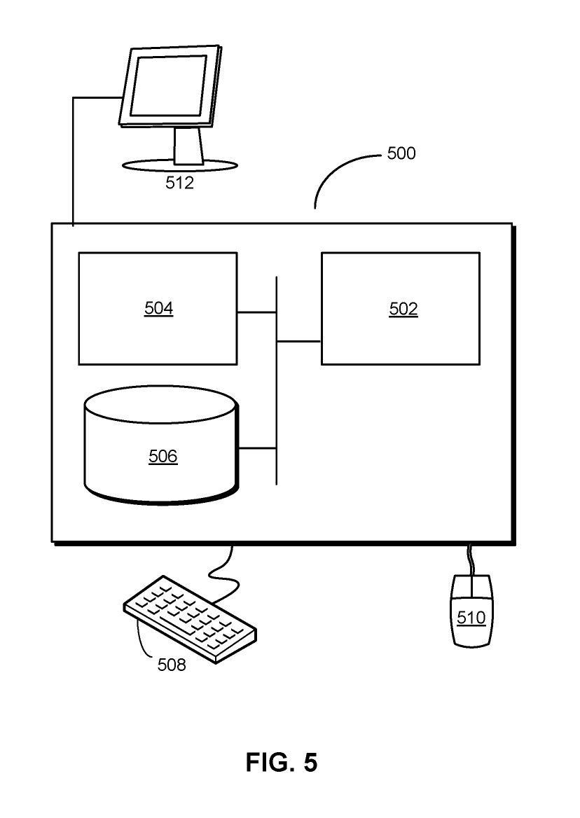

FIG. 5 shows a computer system 500 in accordance with the disclosed embodiments. Computer system 500 includes a processor 502, memory 504, storage 506, and/or other components found in electronic computing devices. Processor 502 may support parallel processing and/or multi-threaded operation with other processors in computer system 500. Computer system 500 may also include input/output (I/O) devices such as a keyboard 508, a mouse 510, and a display 512.

Computer system 500 may include functionality to execute various components of the present embodiments. In particular, computer system 500 may include an operating system (not shown) that coordinates the use of hardware and software resources on computer system 500, as well as one or more applications that perform specialized tasks for the user. To perform tasks for the user, applications may obtain the use of hardware resources on computer system 500 from the operating system, as well as interact with the user through a hardware and/or software framework provided by the operating system.

In one or more embodiments, computer system 500 provides a system for sharing features in a feature management framework. The system includes a repository of feature configurations for a set of features that are accessed across multiple environments. The system also includes a synchronization mechanism, which may alternatively be termed or implemented as a module, apparatus, plug-in, or other type of system component. First, the synchronization mechanism identifies dependencies of the repository and copies shared feature configurations from other repositories represented by the dependencies. The synchronization mechanism then combines the shared feature configurations with existing feature configurations in the repository for use in retrieving feature values for one or more machine learning models.

In addition, one or more components of computer system 500 may be remotely located and connected to the other components over a network. Portions of the present embodiments (e.g., service providers, environments, feature consumers, feature providers, feature management framework, repositories, synchronization mechanisms, etc.) may also be located on different nodes of a distributed system that implements the embodiments. For example, the present embodiments may be implemented using a cloud computing system that manages, defines, generates, retrieves, and/or shares features in a set of remote environments.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
creating a repository of feature configurations for a set of features that are accessed across multiple environments;
identifying, by a computer system, dependencies of the repository;
copying, by the computer system to the repository, shared feature configurations from other repositories represented by the dependencies; and
combining the shared feature configurations with existing feature configurations in the repository for use in retrieving feature values for one or more machine learning models.

2. The method of claim 1, further comprising:
storing one or more private feature configurations in the repository without sharing the one or more private feature configurations with the other repositories.

3. The method of claim 1, wherein creating the repository for organizing the feature configurations comprises:
obtaining a template for organizing the feature configurations; and
creating the repository from the template.

4. The method of claim 3, wherein the template comprises at least one of:
a directory structure for the repository;
one or more configuration files; and
one or more build files.

5. The method of claim 1, wherein identifying dependencies of the repository comprises:
obtaining the dependencies from a build file in the repository.

6. The method of claim 1, wherein combining the shared feature configurations with the existing feature configurations in the repository comprises:
merging the shared feature configurations with the existing feature configurations into one or more configuration files; and
storing the one or more configuration files in the repository.

7. The method of claim 6, wherein combining the shared feature configurations with the existing feature configurations in the repository further comprises:
validating the shared feature configurations prior to merging the shared feature configurations with the existing feature configurations.

8. The method of claim 7, wherein the shared feature configurations are validated using at least one of:
a feature name; and
a feature version.

9. The method of claim 1, wherein the feature configurations comprise at least one of:
an anchor comprising metadata for accessing a first feature in an environment;
a join configuration for joining the first feature with a second feature; and
a feature derivation for generating a third feature from the first feature.

10. The method of claim 1, wherein the feature configurations comprise at least one of:
a first feature configuration for a first feature that is accessed in a single environment; and
a second feature configuration for a second feature that is accessed in more than one environment.

11. The method of claim 1, wherein:
the repository is associated with a feature consumer; and
the other repositories are associated with feature producers.

12. A system, comprising:
one or more processors; and
memory storing instructions that, when executed by the one or more processors, cause the system to:
create a repository of feature configurations for a set of features that are accessed across multiple environments;
identify dependencies of the repository;
copy shared feature configurations from other repositories represented by the dependencies; and
combine the shared feature configurations with existing feature configurations in the repository for use in retrieving feature values for one or more machine learning models.

13. The system of claim 12, wherein creating the repository for organizing the feature configurations comprises:
obtaining a template for organizing the feature configurations; and
creating the repository from the template.

14. The system of claim 13, wherein the template comprises at least one of:
a directory structure for the repository;
one or more configuration files; and
one or more build files.

15. The system of claim 12, wherein combining the shared feature configurations with the existing feature configurations in the repository comprises:
merging the shared feature configurations with the existing feature configurations into one or more configuration files; and
storing the one or more configuration files in the repository.

16. The system of claim 15, wherein combining the shared feature configurations with the existing feature configurations in the repository further comprises:
validating the shared feature configurations prior to merging the shared feature configurations with the existing feature configurations.

17. The system of claim 12, wherein the feature configurations comprise at least one of:
a first feature configuration for a first feature that is accessed in a single environment; and
a second feature configuration for a second feature that is accessed in more than one environment.

18. The system of claim 12, wherein:
the repository is associated with a feature consumer; and
the other repositories are associated with feature producers.

19. A non-transitory computer-readable storage medium storing instructions that when executed by a computer cause the computer to perform a method, the method comprising:
creating a repository of feature configurations for a set of features that are accessed across multiple environments;
identifying dependencies of the repository;
copying shared feature configurations from other repositories represented by the dependencies; and
combining the shared feature configurations with existing feature configurations in the repository for use in retrieving feature values for one or more machine learning models.

20. The non-transitory computer-readable storage medium of claim 19, wherein the method further comprises:
storing one or more private feature configurations in the repository without sharing the one or more private feature configurations with the other repositories.
